(19) United States
(12) Patent Application Publication
(10) Pub. No.: US 2023/0377540 A1
(43) Pub. Date: Nov. 23, 2023

(54) SYSTEM AND METHOD FOR GENERATING AND/OR ADAPTING MUSICAL NOTATIONS

(71) Applicant: Joytunes Ltd., Kfar Saba (IL)

(72) Inventors: Matan Gover, Kfar Saba (IL); Oded Zewi, Kfar Saba (IL); Eran Aharonson, Kfar Saba (IL)

(21) Appl. No.: 18/317,980

(22) Filed: May 16, 2023

Related U.S. Application Data
(60) Provisional application No. 63/351,885, filed on Jun. 14, 2022.
(60) Provisional application No. 63/343,689, filed on May 19, 2022.

(51) Int. Cl. G10G 1/04

(52) U.S. Cl. CPC G10G 1/04

(57) ABSTRACT

Aspects of embodiments to a method for providing a user with musical notations for playing a musical instrument. The method may comprise receiving source musical notation data descriptive of source musical notation information that can be played with a musical instrument and/or sung by one or more users; analyzing the received source musical notation data for generating a source notation analysis output; receiving at least one target requirement defining target musical notation information; and providing, based on the source notation analysis output and the at least one target requirement, target musical notation data descriptive of target musical notation information.

### CROSS-REFERENCE TO RELATED APPLICATIONS

This patent application claims priority from and benefit of U.S. Provisional Patent Application 63/343,689, filed May 19, 2022; and from U.S. Provisional Patent Application 63/351,885, filed Jun. 14, 2022, both titled “SYSTEM AND METHOD FOR GENERATING AND/OR ADAPTING MUSICAL NOTATIONS”, and both of which are incorporated herein by reference in their entirety.

### TECHNICAL FIELD

The present disclosure relates to a method and system for providing a user with musical notations to be played by the user with a musical instrument.

### BACKGROUND

Increasing Internet penetration, smartphones and tablets in the modern and emerging economies are boosting the growth of the online music learning market, as an alternative to the traditional personal one-on-one piano lessons. Various online courses and individual lessons that offer enhanced music skills are provided as applications for mobile phones and tablets, typically based on Windows, iOS, Android, and MacOS platforms, are offered by multiple key players, supporting various musical instruments such as guitar, ukulele, piano, vocal, drums, and bass. In addition to the reduced costs, such online music learning provides an interactive and fun experience, while providing more flexibility and being less bound by location and time, compared to personal based tutoring.

### BRIEF DESCRIPTION OF THE DRAWINGS

The figures illustrate generally, by way of example, but not by way of limitation, various embodiments discussed in the present document.

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. References to previously presented elements are implied without necessarily further citing the drawing or description in which they appear. The number of elements shown in the Figures should by no means be construed as limiting and is for illustrative purposes only. The figures are listed below.

FIGS. 1A and 113 respectively exemplify source and target musical notation information, according to some embodiments.

FIGS. 1C and 1D respectively exemplify source and target musical notation information, according to some embodiments.

FIG. 2 shows a block diagram of a musical notation information generating/adapting system, according to some embodiments.

FIG. 3 shows a flowchart of a method for generating/adapting musical notation information, according to some embodiments.

FIG. 4 shows another flowchart of a method for generating/adapting musical notation information, according to some embodiments.

FIG. 5 shows a flowchart for training a machine learning model for adapting source musical notation information to arrive at target musical notation information, according to some embodiments.

FIG. 6A-C show three different difficulty levels of the experiment. From bottom to top: Pre-Advanced example is fully harmonized with rhythmic bass in the left hand and chords in the right hand. The Example for “Intermediate” is transposed to the easier key of C major and contains a simplified accompaniment. The right hand chords are omitted, and the melody is split differently between the hands to accommodate for less hand shifts. In the “Essentials” example, the accompaniment is reduced to a minimum, and a tied note in the melody is removed to simplify the rhythm.

FIG. 7 schematically shows a data preparation process, according to the experiment, where arrangements of the same song in different playing levels were transposed to the same key, followed by extract matching phrase pairs.

FIG. 8 is a schematic illustration of the MuTE score calculation, according to the experiment. In the illustrated example, target score has an added measure (marked in red) with regard to the reference. The misaligned region was masked (in white) on the piano-rolls. The per-hand sample-wise pitch F1 score was calculated from the aligned piano-rolls, and scores were averaged to get the final MuTE score.

FIG. 9 schematically shows scores per model version, as rated by human experts in the experiment. The best model (Augment) achieved ratings almost as high as human generated examples (Human). Difference in average score, per criterion, between model variants. a) Moving from MIDI to Notes improved across all criteria, mostly Level. b) Adding hand information improved hand assignment. c) Augmentation improved preserving musical content. d) No particular criterion stands out in the difference from our best model to the human-generated ground truth.

FIG. 10 schematically shows differences in average score, per criterion, between model variants.

FIG. 11 illustrates evaluation of the model variants on the test set used in the experiment, using the MuTE score.

FIG. 12 illustrates a scatter-plot, showing the relationship between human ratings and MuTE scores of the experiment. The black line shows a linear regression model fit and the shaded area shows the 95% confidence interval for the regression estimate.

### DETAILED DESCRIPTION

Musicians usually use music sheets bearing musical notation information of a musical piece for instrumentally and/or vocally performing the musical piece. Different users may have different instrument and/or singing skill levels. It may thus be useful to have readily presentable music sheets of a certain musical piece at different levels of difficulty, to match the skill levels of different users.

Aspects of the present invention pertain to a computerized device, system and method for displaying to a user, information relating to the playing of an instrument by the user. The information is displayed to the user using a computerized application executed by the computerized device of the system. Information about the same musical piece may be displayed to the user at different skill levels.

Embodiments may thus pertain to the task of adapting a musical piece associated with a first level of difficulty to one or more (e.g., lower and/or higher) levels of difficulty. For example, source musical notation information may be adapted into less complex or more complex target musical notation information.

In some embodiments, the device, system and method are operable to receive source musical notation information, and to provide, based on a received input, target musical notation information. In some examples, the input may be signal input relating to a user playing the source musical notation information; descriptive of a desired difficulty level for the target source musical notation information; and/or the like.

In some examples, some or all of the received source musical notation information may be adapted for arriving at the target musical notation information. In some examples, target musical notation information may be selected from an available pool of target musical notation information (e.g., a plurality of sets of available target musical notation data). In some embodiments, a selection of first target musical notation information may be made, which may then be adapted to arrive at second target musical notation information, which may be different from the first target musical notation information. Hence, the first target musical notation information may become the source musical notation information for generating the second target musical notation information.

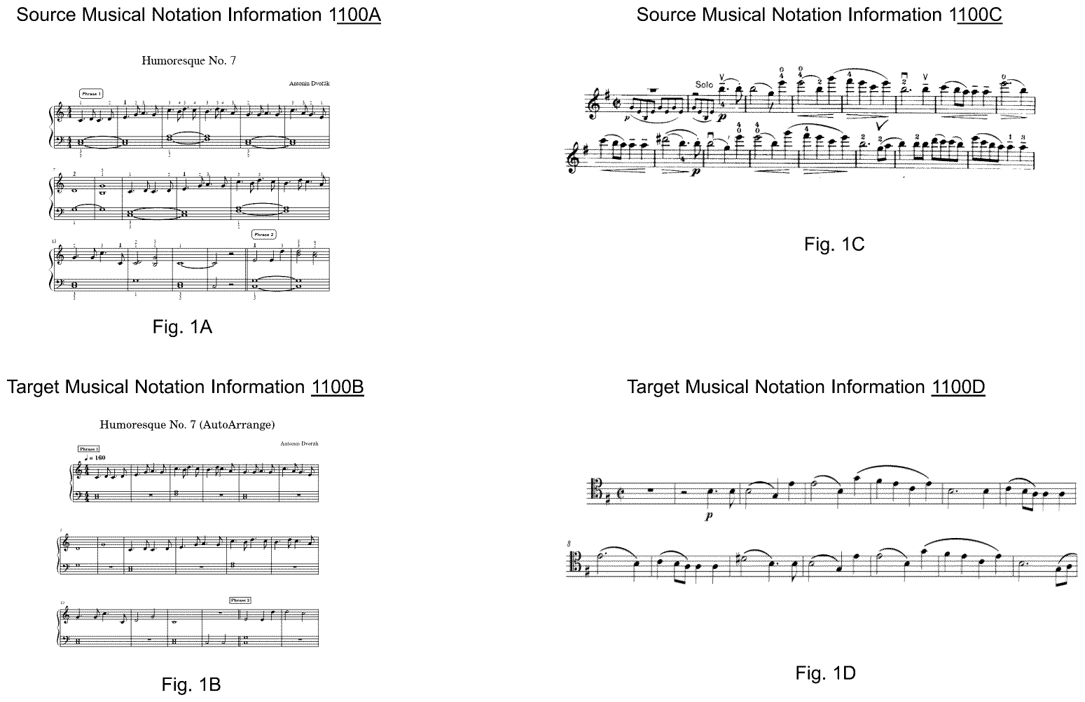

Referring to FIG. 1A, source musical notation for “Humoresque” is shown as source sheet 1100A, and a corresponding example target musical notation as target sheet 1100B is shown in FIG. 1B. Target sheet 1100B contains more rests, fewer notes to be played sequentially (alone and/or concurrently as chords), fewer rhythm-related notations, and the like, compared to source sheet 1100A. Hence, in the example shown with respect to FIG. 1A and FIG. 1B, that target musical notation information is comparatively less complex than the source musical notation information. However, this should by no means be construed as limiting. Hence, in alternative implementations, the target musical notation information may be comparatively more complex than the source musical notation information. In some further example implementations, some aspects (e.g., characteristics, features) of the source musical notation information may be less complex and some more complex than the target musical notation information. The term “complex” as used herein may refer to corresponding objective or subjective level of difficulty for a given player and/or singer to perform the musical piece presented by the musical notation.

In a further example, as exemplified in FIGS. 1C and 1D, source musical notation information suitable for being played by a first instrument may be adapted for a second instrument, different from the first instrument. FIGS. 1C and 1D represent music sheets of Mendelssohn's Violin Concerto in E minor, Op. 64, where FIG. 1C shows the original music piece that was composed for Violin and FIG. 1D an adapted version for Cello.

In some embodiments, the system may be operable to generate target musical notation information based on basic “building blocks” relating to one or more basic musical structures. The building blocks may be combined to provide the target musical notation information. In some examples, the system may present the user (e.g., a musician) with an interactive notation translation tool.

The received input may define target requirements, constraints, preferences, modifications, one or more (e.g., exclusion and/or exclusion) criteria. The input may be provided in the form of a selection, an input, speech input, non-speech input such as, for example, a musical audio signal input and/or a sound input created due to playing an instrument and/or singing, a MIDI input, and/or the like.

Merely to simply the discussion that follows, without be construed in a limiting manner, the term “input” and the expression “target requirement” may herein be used interchangeably.

In some embodiments, adapting source musical notation information into target musical notation information may be performed automatically or semi-automatically, e.g., using “machine-assistance”. For instance, a user may define target requirements and perform edits on generated first target musical notation information to obtain second target musical notation information. Data relating to edits performed by users of the system (e.g., via the “notation translation tool”) may be used as feedback for further improving the system performance. In some examples, systems may concurrently present (e.g., side-by-side) source and target musical notation information for facilitating edits.

In some embodiments, the generated target musical notation information is evaluated using a score. The score may be computed by taking into consideration various target characteristics of the target musical notation information (e.g., rhythmic similarity, pitch correctness, note overlap, alignment metric) and compare the target characteristics with corresponding characteristics of the source musical notation information. The comparison may employ statistical analysis using, for example, pitch distribution, note overlap metric (e.g., rather than note onsets). For example, a half note is considered to overlap or be identical to two consecutive quarter notes of the same pitch. For computing an alignment score, Hamming distance may for example be employed.

In some embodiment, one or more characteristics of the source musical notation information may be adapted to arrive at the target musical notation information. Such notation characteristics can include, for example, scale; a type of instrument intended to be used for playing the target musical notations; vocal range for signing the target musical notations; pitch level; beats per minute (BPM); type of background music (BGM); lead performer role; supportive performer role; time signature; clefs; tempo; note structure such as note length, rest lengths; rhythmic style; lyrics, and/or playing setting (e.g., solo playing, jamming, playing an orchestrated musical piece, improvised playing); and/or the like. For example, a source and target time signature may be the same, while BPM and pitch of the target time signature may be different to the BPM and pitch of the source signature. For example, a user may provide the system with an input relating to a desired pitch level. The system may then transpose the source musical notation information to the desired target musical notation information having the desired pitch. For example, a user may provide the system with an input relating to target BGM. The system may then adapt the source BGM to the desired target BGM.

In some embodiments, the input received for adapting the source musical notation information may define a minimum value (e.g., an open-ended range having a minimum value), a maximum value (e.g., an open-ended range having a maximum value), or a range between a minimum and a maximum. In some examples, the range may include the minimum and/or the maximum value. In some examples, the range may include the minimum and/or the maximum value.

In some embodiments, characteristics such as, for example, structures of the source musical notation information may be identified, for example, by parsing and/or otherwise analyzing the source musical notation information. Based on the received input (e.g., target requirements, constraints), target musical notation information is generated in a manner such that target structures match (also: substantially match) with the corresponding structure of the source musical notation information and meet the target requirements.

The term “structure” as used herein pertains to a sequence of notes and/or rests of the musical notation and may pertain, for example, to a pattern (e.g., melodic pattern, accent pattern, rhythmic pattern), a phrase, a melodic motif, a musical mode (e.g., Ionian, Dorian, Phrygian, Lydian, Mixolydian, Aeolian, Locrian) a musical meter, a bar, a clef (treble and/or bass clef) and/or the like. Different phrases of a musical piece may for example defined as follows “Verse 1”, “Verse 2”, “Chorus”, “Ending”.

In some embodiments, the system may include a musical notation generation and/or adaptation (MGAD) engine configured to analyze received source musical notation information and to adapt the received musical notation information based on the received target requirements to produce the desired target musical information notation. In some examples, the MGAD engine may employ rule-based algorithms, machine learning models (e.g., transformer, recurrent neural networks) and/or the like.

For example, the method may include adapting received source musical notation information by dividing the source musical notation information into smaller segments, pieces or basic (e.g., logic) parts, having associated structure. The method may then include adapting the basic parts to obtain adapted parts, and then combining the adapted parts together to arrive at target musical notation information. Adapting the received source musical notation information may be performed, for example, using a trained machine learning model and/or a rule-based engine.

In some examples, the generation/adaption engine may employ artificial intelligence functionalities such as, for example, a machine learning model that may be trained by experts and/or users such that the machine learning model receives source musical notation information and input data for outputting, based on the source musical notation information and input data, the target musical information notation. In some examples, the machine learning model may be trained offline. In some examples, the machine learning model may be trained online, e.g., by users providing feedback while using the system.

For example, data about a user's performance in accordance with target musical notation information may be fed into the system as feedback (e.g., training data) for generating updated target musical notation information. A user's skill level may be predetermined (e.g., “low”, “intermediate”, “high”) for generating, in accordance with the user's skill level category, updated target musical notation information.

In some embodiments, the system may be configured to determine a user's skill level playing a musical piece and adapt, based on the determined skill level, the target musical notation information to be displayed to the user. Hence, in some examples, the system may be configured to generate personalized target musical notation information to better match each user's skill level. In some examples, adapting the target musical notation information may be performed while the user is performing according to the displayed musical notation information. For example, the first eight bars of a musical piece may be presented to the user as first target musical notation information and, upon successful completion of the first eight bars, the system may adapt the remainder first target musical notation information of the same piece to arrive at updated, second target musical notation information of the same musical piece. The updated target musical notation information may then be presented to the user in a manner allowing the user continuous playing of the musical piece. For instance, a first portion and a second portion target musical notation information having respective difficulty levels, of a same musical piece, may be “stitched” with each other to allow continuous playing of the same piece at respective levels. Data about the user's performance of the first target musical notation information may be input as training data for generating the updated target musical notation information. In some examples, a machine learning model may be employed for implementing some or all of the analysis part of the notation generation/adaptation engine. In some examples, a machine learning model may be employed for implementing some or all of the adaptation parts of the notation generation/adaption engine. In some examples, rule-based logic may be employed for implementing some or all of the analysis and/or the adaptation parts of the engine.

In some embodiments, the system may allow evaluation of the provided target musical notation information. The evaluation may take various forms and may for example be based on one or more performance parameter values including, for example, number of errors made by the user playing the target musical notation information, the progress made by the user, rate of completion of a musical piece, level of difficulty of musical piece presented by the target musical notation information as compared to the user's playing level, a score provided by the user to indicate a level of user satisfaction of the presented target musical notation information and/or the like.

In some embodiments, the user may suggest updated or additional target preferences (e.g., modifications) on the obtained target musical notation information to arrive at updated target musical notation information. In some embodiments, the system may provide updated target musical notation information, based on the provided feedback.

In some embodiments, the feedback may be indicative of a level of correspondence between the target musical notation information provided by the system and an expected target musical notation information. The level of correspondence may be evaluated automatically by another system, by the same system that generated the target musical notation information and/or by a user viewing and, optionally, playing an instrument and/or signing in accordance with the target musical notation information.

In some embodiments, the system may prompt the user to provide feedback in relation to provided (e.g., presented) target musical notation information. In some embodiments, the system may suggest the user to select from a plurality optional target requirements. In some examples, the plurality of suggested optional target requirements may be presented to the user in accordance with feedback received from the user. In some examples, suggested target requirements may assist the user being presented with (updated) target musical notation information providing the user with increased satisfactory results. For example, a comparatively low score may be the result of defining target requirements which are unsuitable to a user's personalized experience. By adopting additional or alternative target requirements, the user may have an improved experience.

In one scenario, a piano player may provide target requirements which relate to lowering BPM of a musical piece, and further by transposing the musical piece to a pitch level which can be played more executed with a piano. The system may then generate the target musical notation information to which the user may provide feedback. Based on the feedback provided by the user, the system may identify that the user's experience may be improved if the source BPM and source pitch level remain the same, and that skipping notes would be more beneficial to the user's experience. Hence, the system would thus suggest the user with additional or alternative target requirements such as retaining the source BPM and the source pitch, while suggesting the skipping of notes instead.

It is noted that the term “user” as used herein may, where applicable, refer to a plurality of users. For instance, input and/or feedback provided by the user may be crowd-sourced input and/or feedback. Furthermore, the term “user” as used herein may pertain to an instrument player playing according to the target musical notation information, a singer singing according to the target musical notation information, a teacher, a musician, an arranger, a sound engineer, a movie director, a music video director, a luthier, a piano technician or any other person repairing instruments, instrument tuner, a person in the audience listening to a musical piece executed in accordance with the target musical notation information, and/or the like.

In some examples, a second user playing in accordance with first target musical notation information, together with a first user playing in accordance with second target musical notation information, may provide input and/or feedback on the target musical notation information presented to the first user. The first target musical notation information may be identical or differ from the second target musical notation information.

In some embodiments, a user may be presented with source musical notation information which the user can use as reference for defining the target requirements. In some other examples, the user may not be provided with source musical notation information, and the user may provide the system with target requirements. In the latter case, the system may receive the target requirements from the user and select, based on the received target requirements, at least one option of source musical notation information. In some cases, one or more options of source musical notation information may be presented to the user. The user may select at least one option of source musical notation information presented to him. Based on the selection made, the system may generate target musical notation information. In some other cases, the system may select, based on the received target requirements, a suitable source musical notation information and present the user with corresponding target musical notation information.

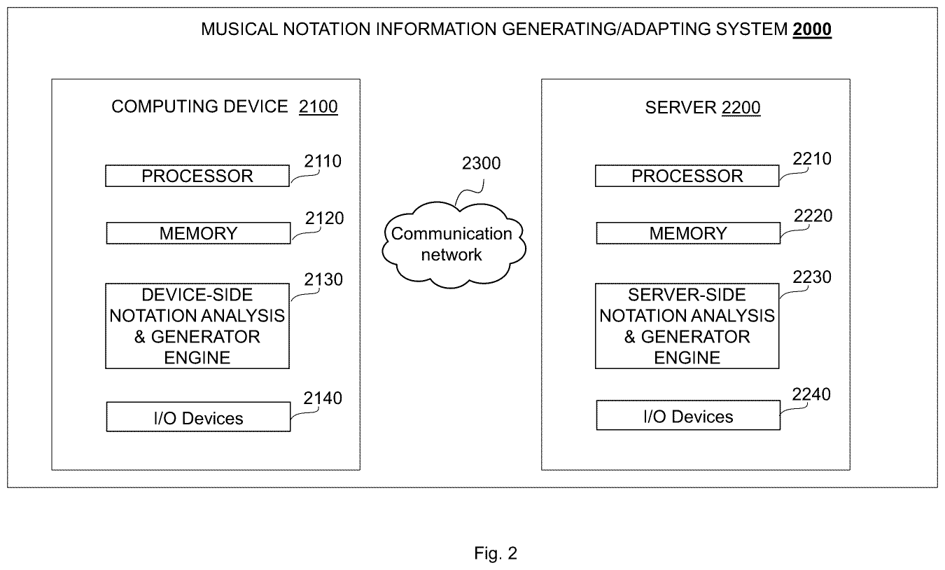

Referring now to FIG. 2, a musical notation generation and/or adaptation (MGAD) system 2000 may include a computing device 2100 and a server 2200. Computing device 2100 and server 2200 may be operable to communicate with each other over a communication network 2300. Network 2300 may be configured for using one or more communication formats, protocols and/or technologies such as, for example, to internet communication, optical or RF communication, telephony-based communication technologies and/or the like. In some examples, the communication module may include I/O device drivers (not shown) and network interface drivers (not shown) for enabling the transmission and/or reception of data over network 2300.

A device driver may, for example, interface with a keypad or to a USB port. A network interface driver may for example execute protocols for the Internet, or an Intranet, Wide Area Network (WAN), Local Area Network (LAN) employing, e.g., Wireless Local Area Network (WLAN)), Metropolitan Area Network (MAN), Personal Area Network (PAN), extranet, 2G, 3G, 3.5G, 4G, 5G, 6G mobile networks, 3GPP, LTE, LTE advanced, Bluetooth® (e.g., Bluetooth smart), ZigBee™, near-field communication (NFC) and/or any other current or future communication network, standard, and/or system.

Computing device 2100 may comprise one or more processors 2110 and one or more memories 2120. Any of processors 2110 may be a Central Processing Unit (CPU), a microprocessor, an electronic circuit, an Integrated Circuit (IC) or the like. Processors 2110 may be utilized to perform computations required by system 2000 and/or any of its subcomponents. System 2000 may further comprise one or more Input/Output devices 2140 and, optionally, Input/Output ports, which may be connected to one or more the Input/Output devices 2140.

Similarly, server 2200 may include a processor 2210, a memory 2220. Executing of computer-executable instructions stored in memory 2220 by processor 2210 may result in a server-side MGAD engine 2230. Server 2200 may further include input/output devices 2240 and, optionally, Input/Output ports, which may be connected to one or more the Input/Output devices 2240.

The term “processor”, as used herein, may additionally or alternatively refer to a controller. Processor 2110 and/or processor 2210 may be implemented by different types of processor devices and/or processor architectures including, for example, embedded processors, communication processors, graphics processing unit (GPU)-accelerated computing, soft-core processors, processors based on quantum technology, and/or general purpose processors.

Memory 2120 and/or memory 2220 may comprise data and algorithm code which, when executed by processor 2110 and/or processor 2210, may result in MGAD engine or application 2130/2230, e.g., as outlined herein.

Memory 2120 and/or memory 2220 may be implemented by different types of memories, including transactional memory and/or long-term storage memory facilities and may function as file storage, document storage, program storage, or as a working memory. The latter may for example be in the form of a static random access memory (SRAM), dynamic random access memory (DRAM), read-only memory (ROM), cache and/or flash memory. As working memory, Memory 2120 and/or memory 2220 may, for example, include, e.g., temporally-based and/or non-temporally based instructions. As long-term memory, Memory 2120 and/or memory 2220 may for example include a volatile or non-volatile computer storage medium, a hard disk drive, a solid state drive, a magnetic storage medium, a flash memory and/or other storage facility. A hardware memory facility may for example store a fixed information set (e.g., software code) including, but not limited to, a file, program, application, source code, object code, data, and/or the like.

Input/output devices 2140 and/or 2240 may include a display device, one or more microphones, one or more speakers, inertial sensors, non-inertial sensors, sensors configured to sense physiological parameter characteristics (e.g., blood pressure, pulse, sweat reate, body temperature, user motion, movement), wearable sensors, non-wearable sensors, image sensors, and/or a communication module for communicating, for example, with a server comprising a database storing music pieces and arrangements, and/or the like.

Input devices are configured to convert human-generated signal, such as, human voice, physical movement, physical touch or pressure, and/or the like, into electrical signals as input data into system 2000. Output devices may convert electrical signals received from computing system 2000 into signals that may be sensed as output by a human, such as sound, light and/or touch.

Input devices of I/O devices 2140 and/or 2240 may for example include, a MIDI input, an audio source (e.g., a musical instrument and/or a microphone), an alphanumeric input device, including alphanumeric and other keys for communicating information and/or command selections to the processor via a port, inertial and/or non-inertial sensors such as cameras, linear acceleration sensors, angular acceleration sensors, gyroscopes, satellite-based navigation systems (e.g., the US-based Global Positioning System), microphones, direction and selection control devices (e.g., joystick, a trackball, a mouse), gravitational sensors, a touch sensitive screen.

Output devices of I/O devices 2140 and/or 2240 may include a display, a touch-sensitive display, a speaker, a tactile output device, a haptic output device. In some examples, the input device and the output device may be the same device, e.g., in the case of a touchscreen.

The components detailed below may be implemented as one or more sets of interrelated computer instructions, executed for example by any of processors 2110 and/or processors 2210. In some embodiments, some of the components may be executed by one computing device while others may be executed by another computing platform such as server 2200. The components may be arranged as one or more executable files, dynamic libraries, static libraries, methods, functions, services, or the like, programmed in any programming language and under any computing environment.

A communication module of I/O devices 2140 and/or 2240 may be configured to enable wired and/or wireless communication between the various components and/or modules of the system and which may communicate with each other over one or more communication buses (not shown), signal lines (not shown) and/or network 2300.

The MGAD engine (implemented, for example, by device-side MGAD engine 2130 and/or server-side MGAD engine 2230) may be configured to implement steps, processes, and/or methods as described herein.

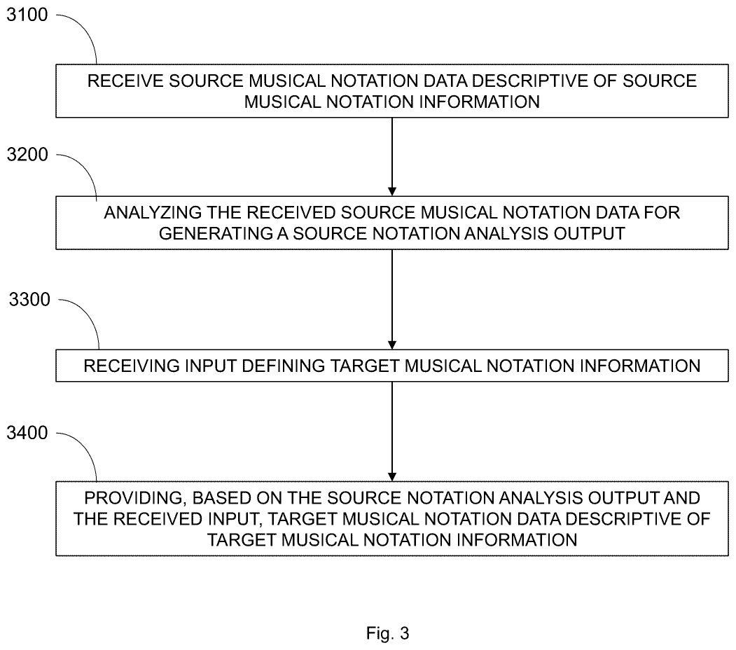

As outlined with respect to FIG. 3, a method for generating and/or adapting musical notation information may include, for example, receiving or loading source musical notation data descriptive of source musical notation information (block 3100). In examples, the method may include processing musical source information to generate corresponding source musical notation data descriptive of musical source notation information. In some examples, musical source information may be provided in various forms and/or formats, including, for example, as audio signals, which may be processed for automatically or semi-automatically providing a transcription of the musical source information to generate the source musical data notation information. The musical source information may also be provided in the form of image information, and/or speech. Examples formats and/or sources of musical source information includes sheet music, tabs, chords, for instance in digital form (e.g., https://musescore.comhttps://musescore.com/), analog form, XML notation, MIDI, etc.), printed sheet music, recorded music, etc. The musical source information can be one file or plurality of files. Different files may pertain to different roles or parts to be performed by different musical performers (e.g., instrument players, singers). Each file may for instance pertain to a different part for singers, bass players, percussion players, string players, brass players, etc.) of source partiture data descriptive of source partiture information.

It is noted that, in some instances without be construed as limiting, the expression “sheet music” and “musical notation information” may herein be used interchangeably.

The method may further include analyzing the received source musical notation data for generating a source notation analysis output (block 3200). For example, the method may include identifying structure in relation to corresponding source musical notation information. Structures of the source musical notation information may be identified, for example, by parsing and/or otherwise analyzing the source musical notation information. In some examples, beat grid information may be provided and/or extracted to ensure metrical coherence of the target musical notation information.

The method may further include receiving input defining target musical notation information (block 3300). Based on the received input (e.g., target requirements, constraints), target musical notation information is generated or provided (block 3400), for example, in a manner such that the structures of the target musical notation information meet the target requirements and match with the corresponding source structure.

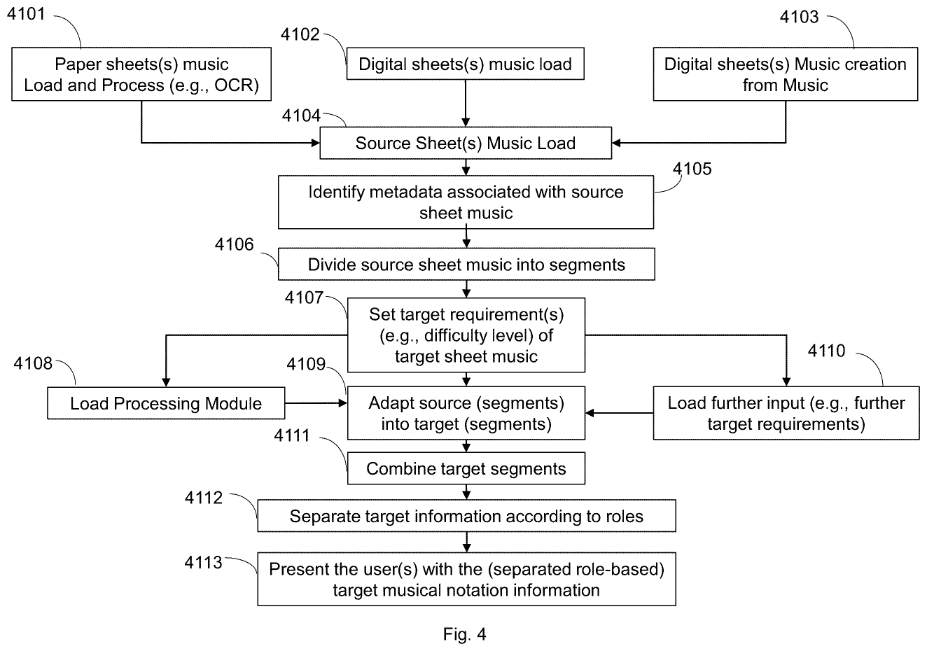

Further reference is now made to FIG. 4. Blocks 4101-4103 exemplify receiving modules of source sheet musical notation information which may, in some examples, include adapting the received source musical notation information from a non-digital source format or a source digital format into a desired digital format. Source sheet musical notation information may represent, for example, tabs, chords, and/or the like. Each module is an example of the different types of sheet music that can be loaded. Source musical notation information may pertain to one or more parts of a same musical piece to be performed and may be uploaded at once for all parts or one by one for each part.

For example, block 4101 may pertain to a loading and adaptation module for paper sheet music. The sheet music may be scanned and then adapted (automatically and/or with human assistance and/or under human supervision) into a desired digital format for representation. A desired format may be a data format processable by a digital sheet display software such as SmartScore™ provided by Musitek (https://www.musitek.com/).

In some examples, as indicated by block 4102, source musical notation information may be provided in a digital source format and, if required, adapted into a desired digital format.

In some examples, as indicated by block 4103, source musical notation information may be provided as audio signals, optionally converted from sound signals and converted into a desired digital format using a automated transcription tools (e.g., Google's Magenta https://magenta.tensorflow.org/transcription-with-transformers, website visited 17 May 2022).

In some examples, as indicated by block 4104, the data (in the desired digital format) descriptive of the source musical notation information is provided to a memory 2120 and/or memory 2220 of a processing unit for implementing MGAD engine 2130 and/or MGAD engine 2230.

In some examples, as indicated by block 4105, the method may include identifying metadata descriptive metainformation associated with source musical notation information such as, for example, a level of complexity and/or instrument class, with respect to received source musical notation information.

For example, a level of complexity can be set manually (e.g., by a human transcriber), automatically, or semi-automatically, for instance, based on symbols provided by the musical notation information. Automated methods for determining sheet music complexity (or level of difficulty or complexity of musical notation information) may for instance employ a method described in “Ghatas, Y., Fayek, M., & Hadhoud, M. (2022). A hybrid deep learning approach for musical difficulty estimation of piano symbolic music. Alexandria Engineering Journal, 61(12), 10183-10196”, which is incorporated by reference in its entirety.

It is noted that the expressions “level of complexity”, “complexity level”, “level of difficulty” and “difficulty level” may herein be used interchangeably.

As indicated by block 4106, the method may for example include (virtually) dividing or performing segmentation of the source musical notation information into smaller overlapping or non-overlapping pieces, basic parts, chunks, segments and/or portions. It is noted that the expressions pieces, basic parts, chunks, segments and/or portions may herein be used interchangeably. The segmentation may be performed according to a certain logic (e.g., rule-based algorithm, machine learning model), or manually.

In some examples, each segment may have associated therewith a defining feature. In some examples, a plurality of sets of segments may be obtained, where the segments of each set may share a common distinguishing feature (e.g., melody, rhythm, chord progression). Segmentation of source musical notation information may be based on musical notation symbols such as, for example, markings, lines, measures, etc. and/or the like. In some examples, a user may provide the system with segmentation markers. In some examples, the segmentation may be performed automatically, semi-automatically (partially based on human input), or entirely based on user-input.

In some examples, the method may include automatically identifying logic structures in the received source musical sheet information and perform segmentation based on the identified logic structures (e.g., notation patterns, phrases, and/or the like). For instance, non-overlapping or partially overlapping musical notation patterns may be identified as different segments.

In some examples, as indicated by block 4107, the method may include providing an input for defining the expected target sheet music to be created. The input can relate one or more of the following: target sheet music complexity level, music device, constraints, BGM to be used, etc.

In some examples, as indicated by block 4108, the method may include providing (e.g., loading) a data processing module (implementing, for example, a trained machine learning model and/or rule-based algorithm) into a control unit for adapting source musical notation information (e.g., which may be segmented or non-segmented) into target musical notation information. For example, data and/or instructions may be provided to a memory for processing by a processor for implementing an MGAD engine.

It is noted that the expression “adapting” as well as grammatical variations may also encompass the meaning of the expression “transcribing”, “transforming” and/or “converting.”

In some examples, different processing modules may be employed, depending on the target requirements. For example, if the target musical notation information is defined as “entry-playing level with BGM”, then a first processing module (e.g., ML module) may be selected operable to transcribe the source musical notation information determined as medium-level difficulty, into entry-level playing level along with a suitable BGM. In a further example, if the target musical notation information is defined as “high-playing level without BGM”, then a second processing module (e.g., ML module) may be selected operable to transcribe a source musical notation information determined as low-level difficulty, into high-level playing level, without BGM.

As indicated by block 4109, the method may for example include adapting the source musical notation information into target musical notation information. In some examples, the adapting of the source musical notation information may include separating and/or spatio and/or temporally aligning between separate parts that are to be performed by different body parts of a given user (e.g., left hand, right hand, left foot, right foot), and/or by different performers (instrument players and/or singers) to arrive at the target musical notation information.

In some examples, as indicated by block 4110, the method may include providing additional target requirements for adapting source musical notation information into target musical notation information. Additional target requirements may for example pertain to target octaves, target chords, target BPM, etc. In some examples, block 4110 may be merged with block 4107.

As indicated by block 4111, the method may for example include, where applicable, combining segmented target musical notation information into non-segmented target musical notation information to obtain a coherent sheet music. The combining may include solving for overlapping logic segments, smoothing and/or stitching between edges of logical segments.

As indicated by block 4112, the method may for example include separating the created target musical notation information into different role-specific target musical notation information to present the user with respective role-based target sheet music. For example, separate sheet music notations may be presented for each user. For instance, a singer may be presented with target sheet music containing only musical notations to be sung, and a drummer may be presented with target sheet music presenting only musical notation of the drummer section.

As indicated by block 4113, the method may for example include presenting the user(s) with the resulting (role-based separated) target musical notation information.

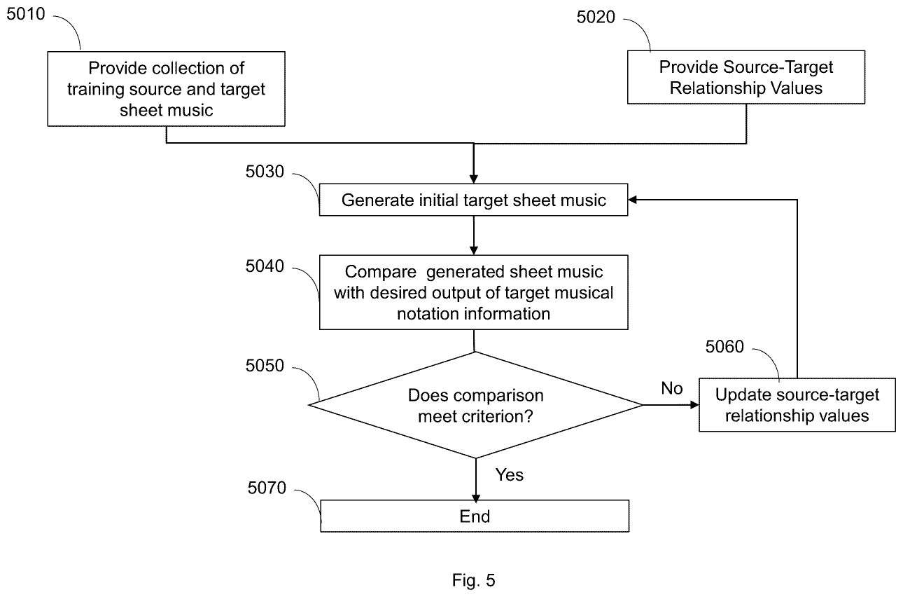

Additional reference is made to FIG. 5, which schematically illustrates a method for creating a machine learning model for adapting source musical notation information into target musical notation information. Data descriptive of the obtained machine learning model may be loaded in block 4108 for implementing the MGAD engine.

Blocks 5010, 5020, and 5030 may exemplify training input data employed for creating the machine learning model. Training input data may for example be descriptive of training source musical notation information, training target musical notation information, and relationship information, e.g., which source musical notation information is associated with which target musical notation information. In some examples, training metadata descriptive of notation metainformation such as complexity level, instrument type and/or the like, may be provided for associating training data descriptive of source musical notation information with training data descriptive of target musical notation information. In some examples, the training metadata may also relate to and/or define target requirements that can be provided by the user for generating the target musical notation information during runtime.

For example, training source musical notation information for a certain instrument (e.g., piano) at a source difficulty level (e.g., entry level) may be associated with training target musical notation information for the same instrument at a target difficulty level (e.g., intermediate level and/or at advanced level) that is different from the source difficulty level. Additionally, the training source musical notation information for a certain instrument (e.g., piano) at entry level may be associated with training target musical notation information for at least other instrument at the same difficulty level and/or at another difficulty level (e.g., intermediate level and/or at advanced level).

As exemplified by block 5010, an input set of source and target musical notation information may be provided. The source and the target may (e.g., independently) share one or more common features such as associated instrument type and/or complexity level.

As exemplified by block 5020, data descriptive of initial relationship values between training source sheet music and target sheet music is provided.

As exemplified by block 5030, the method includes generating initial target sheet music.

As exemplified by block 5040, the method includes comparing the initial target sheet music with desired example target sheet music that was optionally provided in block 5010.

As indicated by block 5050, the method may then include determining whether the initial target sheet music satisfies at least one criterion (e.g., threshold is below a predefined error margin). If the at least one criterion is not met, the source-target relationship values may be updated (block 5060) to generate an updated target sheet music (block 5030). If the at least one criterion is met, the process may end (block 5070).

The above steps may be employed for creating a machine learning model such as a decision tree, an artificial neural network, and/or the like.

In some examples, the blocks 5010 to 5070 may be applied on source sheet segments for training a machine learning model. In some examples, the machine learning model may be fed with source sheet music segments for generating target sheet music segments.

For example, metadata of source musical notation information may first be identified (block 4105). Furthermore, source musical notation information may be divided into segments (4106), before data descriptive of (training) source musical notation information is fed into the (to be trained) machine learning model for creating the target musical notation information according to at least one target requirement, which is provided in block 4107. In a further example, following the creation of target segments with the machine learning model, the target segments may be combined and further processed, e.g., as outlined with respect to blocks 4111-4113.

In some embodiments, different machine learning models may be employed for different purposes, as defined by target requirements.

In some embodiments, a machine learning model may be trained to be employable for generating target musical notation information at a higher difficulty level compared to difficulty level of the source musical notation information.

In some embodiments, a machine learning model may be trained to be employable for generating target musical notation information at a lower difficulty level compared to the source musical notation information.

In some embodiments, a machine learning model may be trained to be employable for generating target musical notation information to be played by a target class of instruments which is different from a source class of instruments, at a same level of difficulty as the source class of instruments or at a different level as the source class of instruments.

Discussions herein utilizing terms such as, for example, “processing”, “computing”, “calculating”, “determining”, “establishing”, “analyzing”, “checking”, “estimating”, “deriving”, “selecting”, “inferring”, “recording”, “updating” and/or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes. The term determining may also refer to “heuristically determining” or “using heuristics”. For example, heuristics may be employed for identifying source structures of musical information notation to arrive, based on the received target requirements, at related target structures. In further examples, heuristics may be used for associating source with target structures for deriving source-to-target relationship values.

### ADDITIONAL EXAMPLES

Example 1 pertains to a method for providing a user with musical notations for playing a musical instrument, the method comprising:
receiving source musical notation data descriptive of source musical notation information that can be played with a musical instrument and/or sung by one or more users;
analyzing the received source musical notation data for generating a source notation analysis output;
receiving at least one target requirement defining target musical notation information; and
providing, based on the source notation analysis output and the at least one target requirement, target musical notation data descriptive of target musical notation information.

Example 2 includes the subject matter of Example 1 and, optionally, wherein the providing of target musical notation data includes adapting the source musical notation data to arrive at the target musical notation data.

Example 3 includes the subject matter of any one or more of the examples 1 to 2 and, optionally, wherein the providing of target musical notation data includes selecting, based on the source notation analysis output and the at least one target requirement, a set of target musical notation data from a plurality of sets of available target musical notation data.

Example 4 includes the subject matter of any one or more of the examples 1 to 3 and, optionally, wherein the source notation analysis output relates to the following:
identifying one or more instruments that can be engaged for playing the source musical notation information;
a source difficulty level of the source musical notation; and/or
a source style relating to the source musical notation information.

Example 5 includes the subject matter of any one or more of the examples 1 to 4 and, optionally, wherein the at least one target requirement of the target musical notation information relates to the following:
at least one target difficulty level;
at least one target style;
at least one target musical instrument for playing the target musical notation information;
at least one physiological characteristic of at least one target user playing an instrument according to the target musical information; and/or
at least one social characteristic of the at least one target user.

Example 6 includes the subject matter of any one or more of the examples 1 to 5 and, optionally, wherein the at least one target requirement is used to define the following musical notation characteristics:
scale; beats per minute; time signature; clefs; tempo; note structure such as note length, rest lengths;
rhythmic style; and/or playing setting.

Example 7 includes the subject matter of examples 5 and/or 6 and, optionally, wherein the target difficulty level is characterizable by the following musical notation characteristics: scale; beats per minute; time signature; clefs; tempo; note structure such as note length, rest lengths; rhythmic style; and/or playing setting.

Example 8 includes the subject matter of any one or more of the examples 1 to 7 and, optionally, wherein the adapting of the source musical notation data is performed by employing a Machine Learning (ML) Model.

Example 9 includes the subject matter of any one or more of the examples 1 to 8 and, optionally, comprising displaying information relating to the target musical information data.

Example 10 includes the subject matter of any one or more of the examples 1 to 9 and, optionally, wherein the target musical notation information is a simplified or more complex version of the source musical notation information.

Example 11 pertains to a system for providing a user with musical notations for playing a musical instrument, the system comprising:

at least one processor configured to execute computer code instructions stored in the at least one memory for performing:

receiving source musical notation data descriptive of source musical notation information that can be played with a musical instrument and/or sung by one or more users;
analyzing the received source musical notation data for generating a source notation analysis output;
receiving at least one target requirement defining target musical notation information; and
automatically providing, based on the source notation analysis output and the at least one target requirement, target musical notation data descriptive of target musical notation information.

Example 12 includes the subject matter of example 11 and, optionally, wherein the providing of target musical notation data includes adapting the source musical notation data to arrive at the target musical notation data.

Example 13 includes the subject matter of the examples 11 and/or 12 and, optionally, wherein the providing of target musical notation data includes selecting, based on the source notation analysis output and the at least one target requirement, a set of target musical notation data from a plurality of sets of available target musical notation data.

Example 14 includes the subject matter of any one or more of the examples 11 to 13 and, optionally, wherein the source notation analysis output relates to the following:
identifying one or more instruments that can be engaged for playing the source musical notation information;
a source difficulty level of the source musical notation; and/or
a source style relating to the source musical notation information.

Example 15 includes the subject matter of any one or more of the examples 11 to 14 and, optionally, wherein the at least one target requirement of the target musical notation information relates to:
at least one target difficulty level;
at least one target style;
at least one target musical instrument for playing the target musical notation information;
at least one physiological characteristic of at least one target user playing an instrument according to the target musical information; and/or
at least one social characteristic of the at least one target user.

Example 16 includes the subject matter of example 15 and, optionally, wherein the at least one target requirement is used to define the following musical notation characteristics: scale; beats per minute; time signature; clefs; tempo; note structure such as note length, rest lengths; rhythmic style; and/or playing setting.

Example 17 includes the subject matter of examples 15 and/or 16 and, optionally, wherein the target difficulty level is characterizable by the following musical notation characteristics: scale; beats per minute; time signature; clefs; tempo; note structure such as note length, rest lengths; rhythmic style; and/or playing setting.

Example 18 includes the subject matter of any one or more of the examples 11 to 17 and, optionally, wherein the adapting of the source musical notation data is performed by employing a Machine Learning (ML) Model.

Example 19 includes the subject matter of any one or more of the examples 11 to 18 and, optionally, configured to display information relating to the target musical information data.

Example 20 includes the subject matter of any one or more of the examples 11 to 19 and, optionally, wherein the target musical notation information is a simplified or more complex version of the source musical notation information.

### EXAMPLE EXPERIMENTS

Reference the following description is based on a paper titled “Music Translation: Generation Piano Arrangements in Different Playing Levels”, submitted to the 23^{rd} International Society for Music Information Retrieval Conference (ISMIR 2022), and which is incorporated by reference herein in its entirety.

A novel task of “playing level conversion” is presented by generating a music arrangement in a target difficulty level, given another arrangement of the same musical piece in a different level. For this task, a parallel dataset of piano arrangements was created in two strictly well-defined playing levels, annotated at individual phrase resolution, taken from the song catalog of a piano learning app.

In a series of experiments, models were trained that successfully modify the playing level while preserving the musical ‘essence’. The experiments further showed, via an ablation study, the contributions of specific data representation and augmentation techniques to the model's performance.

In order to evaluate the performance of our models, a human evaluation study was conducted with expert musicians. The evaluation showed that the best model used in the experiments creates arrangements that are almost as good as ground truth examples. Additionally, use of MuTE was proposed, an automated evaluation metric for music translation tasks, and showed that MuTE correlates with human ratings.

The experiments conducted were aimed at generating piano arrangements for specific playing difficulty levels, conditioned on piano arrangements of the same music in a different playing level.

What was driving this work is to significantly accelerate the rate of content creation for our piano learning app. In this app, a library of songs is used for beginner piano learners to practice. The library contains arrangements at various playing levels, to match the skills acquired by our learners over their piano journey. Arrangements were prepared by expert musicians based on a pre-defined set of piano pedagogy guidelines. These guidelines are strict and are designed to maintain a uniform playing method and skill level in order to help learners familiarize themselves with the piano in a systematic way. The aim is to be able to automatically generate multiple arrangements, spanning our range of playing levels, from a single human-generated arrangement at a given level.

The techniques that were used could also be applied to arrangements for instruments other than piano, or for other music translation tasks.

The task of playing level conversion was introduced and an automated evaluation metric was developed that can be used for music translation or generation tasks where a reference is available. This automated evaluation metric provides a fast, low-effort estimation of human ratings.

Data Preparation and Representation

The dataset of piano arrangements was taken from the song library of a piano learning app. For each song in the library, expert musicians created arrangements in up to three levels: Essentials (easy), Intermediate, and Pre-Advanced (more difficult but still aimed at learners). Strict arrangement guidelines were developed by musicians to create an approachable and engaging learning path for users. A pedagogy system was used based on hand positions, where the aim is to initially minimize the player's need to shift their hands, and then gradually introduce new hand positions and musical concepts as users progress.

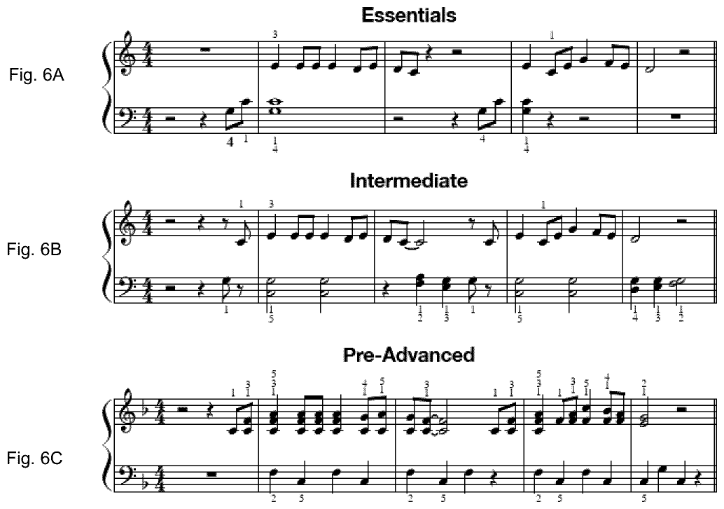

FIGS. 6A-6C illustrates the three different difficulty levels. In the experiment, we focused on two levels: Essentials and Intermediate. Specifically, the task of translating from Intermediate to Essentials was tackled. The main difference between the two levels is in hand positions, rhythmic complexity, and harmonic complexity (amount of simultaneous notes). In Essentials, only a small number of positions was allowed, and position shifts were kept to a minimum. The number of chords were kept small and emphasized the melody. The range of allowed pitches and rhythms was also limited: in Essentials tied notes or sixteenth notes are generally not used. In both Essentials and Intermediate, tuplets and multiple independent voices on the same staff are not used.

When approaching the task of song level translation, initial experiments showed that translating entire songs at once is a difficult task: models we trained did not learn a meaningful mapping between levels. The reason is probably that song structure can vary greatly between levels in our dataset. That is, some levels of the same song omit certain phrases, while other levels include extra phrases, or change the phrase order. It seems that for full-song mapping, a larger (or cleaner) dataset is needed.

For this reason, the work focused on translating individual musical phrases. Fortunately, we could make use of existing annotations for this purpose. Each of the arrangements is divided by musicians into phrases, based on the song structure. For example, a song could have the following phrases:

Intro, Verse 1, Verse 2, Chorus, Verse 1, Ending. Phrase names stay consistent between different levels of the same song, allowing for minor variations such as ‘Phrase 1″Phrase 1a’.

Phrase boundary annotations were used to derive a dataset of parallel phrases from our library of arrangements.

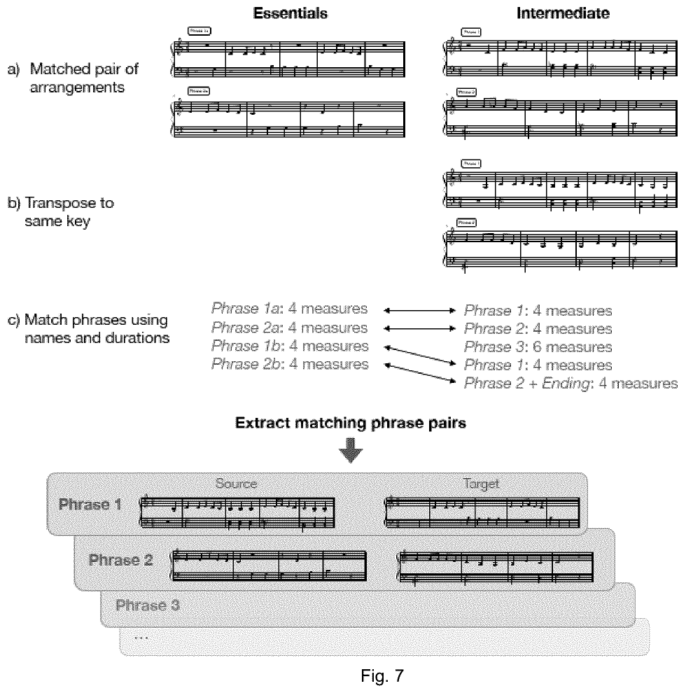

This is schematically illustrated in FIG. 7. Dataset derivation was started from two parallel arrangements of the same song in the source and target levels. Arrangements were discarded where the target and source have different time signatures. The source arrangement was then transposed to the same key as the target arrangement (see additional details below).

Following that, phrases were matched from the source and target levels using heuristics that consider phrase order, names, and/or durations. These heuristics were crucial for obtaining a dataset of sufficient size. To account for added or removed phrases, a difference score was computed between the source and target phrase names. Phrases with exact name (and order) matches are then considered to be parallel if their duration difference is 2 measures or less. For phrases with no exact name matches, we compute the difference score on the phrase durations instead, and considered phrases as parallel if their durations matched and their names were sufficiently similar.

In some songs, different levels were written in different keys (e.g., Essentials in C major and Intermediate in D major), to fit the arrangement to the desired playing level. It was important that source and target phrases maintain the same key, so that the model could learn a consistent mapping. Since the dataset had no key annotations, a heuristic method was implemented for transposition estimation.

Initially, existing methods were tried out for key estimation [25] for each of the phrases, however these were not accurate enough. Since estimation of the transposition was needed (and not the actual key), a dedicated heuristic was heuristically developed:

Convert each of the arrangements (source s and target t) into a “pitch-class piano-roll”, a Boolean matrix (Pₛ and Pₜ) with time and pitch-class dimensions, in which 1 signifies the given pitch-class is active at the given time. The pitch-class overlap (ΣPₛ∩Pₜ) between the piano-rolls for each possible transposition (out of 12 possibilities) was then computed, and selected the one that gives the maximum overlap. This value was then used to transpose the source level's phrases to match the target level's key.

Music Representations

Sequence-to-sequence models such as Transformer operate on a stream of tokens. In order to use these models, music must be represented as a sequence, even if it is polyphonic or consists of multiple tracks. Since symbolic music is multi-dimensional in nature, various ways to turn music into a token sequence have been proposed. MidiTok [26] gives a good summary of various representations.

It was crucial to choose a representation that fits the given task. Experiments were conducted with three representations for piano music: MIDI-like, Notes, and Notes+Hands. The MIDI-like representation uses note on and note off tokens, along with time shift tokens to signify the passing of time [2, 27]. MIDI-like representations are commonly used, perhaps because it is easy to derive them directly from MIDI files. For the present use case, the MIDI-like representation had two limitations: it forces the model to meticulously track active notes in order to later output corresponding note off tokens (potentially leading to syntax errors), and it does not encode the metrical structure of music, potentially leading to compound alignment errors if a single time-shift is wrong.

To counter these problems Notes representation was employed, which uses three tokens for each note: offset, pitch, and duration. The offset token signifies the note's time offset from the beginning of the measure. A ‘bar’ token is output at the beginning of each measure. This is similar to REMI [6] (but without velocity tokens), in that it (partially) encodes the metrical structure of music.

Since the desired output is sheet music, two separate staves had to be output for the right and left hands. Since the MIDI-like and Notes representations do not encode track information, a heuristic was employed by which all notes on or above middle C are assigned to the right hand, and any note lower than middle C is given to the left hand. Chords (notes with identical onset and offset times) were always grouped to one hand. This heuristic generally matched the dataset's specific characteristics, but was quite coarse and led to hand assignment errors.

To solve this, the Notes+Hands representation was used which is identical to the Notes representation but adds an additional ‘hand’ token to each note. As stated in [15] such a representation emphasizes the harmonic (‘vertical’) aspect of music. In the case of piano music, sorting notes by time (and only then by track) emphasizes the overall coherence of the two piano hands over the melodic coherence of each hand separately.

Data Augmentation

Since the dataset used small, even small models quickly overfit it, limiting the ability to scale model size, consequently limiting the amount of information the model can learn. Previous work has shown that data augmentation can turn an overfitting problem into an underfitting problem, allowing iteratively increasing model size [28]. This protocol was followed by gradually adding data augmentation methods and increasing model size to improve the final results.

To match our translation task, augmentations were needed that meaningfully alter both source and target phrases, without corrupting the relationship between them. To achieve this goal, the following augmentation methods were implemented: adding empty measures at random locations; randomly cutting the beginning or end of phrases; removing some measures randomly; and rhythm augmentation (doubling the duration of each note) in some measures.

Transposition was purposefully not included in the list of augmentations, even though it is commonly used in other works. As described above, the arrangement style in the dataset used in the present work is not transposition-invariant: many features depend on absolute pitch such as hand positions, fingering, key signatures, range limits and hand allocation

### Example Model

A classic Transformer model [1] was used, specifically the BART [30] encoder-decoder implementation from the Hugging Face transformers library [31] The specifics of this implementation (compared to classic Transformer) are that it uses learned position embeddings (slightly better results were identified with these compared to sinusoidal embeddings) and GeLU rather than ReLU as the activation function (this did not seem to make a difference in our experiments). As in the original Transformer, a shared weight matrix was used for the encoder, decoder, and output embedding layers.

Experiments were conducted with various model configurations: model dimension, number of layers, number of attention heads. It was found that larger models (d_{model}>64) quickly overfit our training dataset and do not achieve good performance on the validation dataset. The optimal model dimension was found to be 32-64 (with the feed-forward layer dimension always set to 4 d_{model} as in the original Transformer). The optimal number of layers was 3 to 5, depending on the amount of data augmentation. As discussed in herein, use of more data augmentation enabled us increase model size without overfitting the data.

The model was trained using the Adam optimizer [32] to train, with [symbol] ₁=0.9, [symbol] ₂=0.999, ϵ=10⁻⁸, at a learning rate of 0.003 and 1,000 warmup steps.

The dataset used contains a total of 5,543 phrase pairs taken from 1,191 songs. The data was split into train (5,241 phrases), validation (244 phrases), and test (58 phrases) splits. The phrases were split by song (never including phrases from the same song in different splits) to avoid data leakage between splits. The validation set was used to stop model training after validation loss stopped decreasing. The test set was used for final evaluation.

During prediction, the model outputs a probability distribution for the next output token given all the input tokens and the previous output tokens. However, if at each decoding step the most likely output is picked (greedy decoding), we might end up with a non-optimal sequence [33]. Experiments were conducted with two decoding methods: beam search and sampling. It was found that sampling produces more diverse results (due to its random nature), but beam search produces overall superior results for our task.

Interface for Interactive Use

While the model can be used unattended to create arrangements in the target level, in practice it was found that it is beneficial to keep musicians “in the loop” by allowing them to use the model interactively rather than in a ‘fire and forget’ fashion. An interface was created in which a musician can load a source arrangement, translate it phrase-by-phrase to the target level, and review the results side by side. Furthermore, the auto-regressive nature of the model enables interesting use cases: a musician could manually modify some notes and ask the model to re-generate the subsequent music accordingly. Additionally, if random sampling decoding is used, it would be possible to generate multiple alternatives for each measure using different random seeds and offer the musician a choice. It would also be possible to offer knobs that control sampling parameters such as temperature (for controlling the output diversity vs. quality trade-off) or top-k/top-p thresholds (ways of eliminating unlikely outputs to increase the probability of choosing more likely predictions).

In this way, the created model becomes part of the creative process, rather than replacing it. It becomes a tool that assists musicians in their job.

Evaluation Metric

Evaluation is often difficult for music generation due to the absence of pre-defined criteria and because output quality is subjective [34] Standard practices are reporting perplexity (the likelihood of the ground truth test data given the trained model) and conducting human evaluation studies [2, 5, 9, 15, 27]. Some works also calculate scores based on distributions of certain musical features, either comparing generated data to ground truth distributions [9, 15, 35] or using self-similarity in the generated data itself [3].

In machine translation (of text), evaluation metrics such as the popular BLEU metric [36] have been developed to measure the correspondence between generated translations and ground truth references. BLEU has been shown to correlate with human rating. To this end, the use of MuTE (Music Translation Evaluation) was proposed, an automated evaluation metric for symbolic music translation or generation tasks where a reference is available.

MuTE is a score between 0 and 1. Like BLEU and similar metrics, it is designed to reflect the correspondence between a machine-generated example and a human-generated reference. BLEU measures word n-gram precision (the portion of correct predictions out of all predictions) and deliberately omits recall because of the desire to allow for multiple reference translations of the same phrase. In our case, we only had a single reference for each phrase, hence both precision and recall were easily used, and combined them using the harmonic mean to give the commonly used F1 score [37].

MuTE works by treating the model as a multi-label classifier that predicts at every time step what pitches are active. To compute the MuTE score, the reference and target music were converted to a piano-roll representation (a Boolean matrix with dimensions time and pitch), and calculated the F1 score over pitches. Since music is inherently time-based, a global score for the entire piece was not computed since that would mean disregarding note order and timing. Instead, each time-slice of the piano-rolls was treated as an individual sample, computed an F1 score for each time-slice, and averaged those scores.

For time-slices where both the reference and target are silent (and hence precision and recall calculation would result in division by zero), the score was set to 1.

It was also needed to account for cases in which the target differs from the reference in its duration—if, for example, the model ‘skips’ some measures of the input. A procedure was designed that was intended to match the way a human would judge such cases, by detecting skipped or added measures and adjusting the comparison accordingly. For this, the scoring step was preceded with a measure-level alignment procedure. Alignment was performed using dynamic time warping [38]. The feature vectors for the alignment are each measure's pitch-class piano-roll. It was found that using pitch-class piano-rolls gives a more robust alignment compared to regular piano-rolls. The distance between each two feature vectors was computed using the Hamming distance (the proportion of elements that disagree between the two vectors). The computed alignment path was used to align the reference and target's (regular) piano-rolls. The aligned piano-rolls were used to compute the F1 score, while masking out the misaligned segments to assign them a score of 0, thus penalizing the model for any alignment errors.

One additional element of MuTE that pertains to our use case was the desire to reflect the separation between the two hands: by penalizing wrong hand allocation of notes. For this reason, ‘track-specific’ MuTE was used to calculate a separate MuTE score for each hand and average them to get the final score. It was found the mean-of-hands metric correlate better with human ratings than the vanilla MuTE score calculated over both tracks combined.

It was noted that the measure-based alignment method is specifically suitable for the use case because a measure-based representation was used for the models, and it was noticed that models sometimes omit or repeat some measures. For other use cases, the alignment could be computed over individual time steps or beats, or skipped altogether.

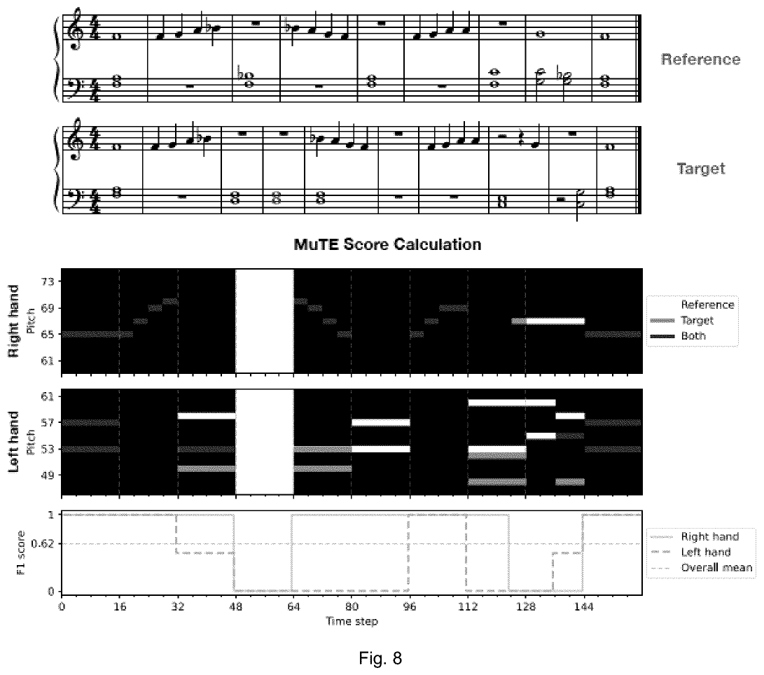

FIG. 8 schematically illustrates the calculation of the MuTE score. As discussed herein below, it was shown that the MuTE score correlates with human ratings. While simple and effective, the MuTE score has caveats. First, it does not differentiate between sustained and repeated notes. For example, a half note is considered identical to two consecutive quarter notes of the same pitch. Second, it does not allow for minor variations that might be acceptable to a human rater, such as octave changes and rhythmic variations. Third, the hand-specific version does not account for notes that are missing in one hand but present in the other hand.

Results

The results of the experiments on converting Intermediate level arrangements were reported to Essentials, and compared the models' outputs to matching reference arrangements created by expert musicians. For evaluation, a human evaluation study was calculated, MuTE scores were calculated, and the correlation between human ratings and MuTE scores was reported. Furthermore, several ablation studies were run to study the effect of our data augmentation techniques and the choice of music representation.

Human Evaluation Study

For the Human Evaluation Study 11 songs were selected from the test set (none of these songs' phrases appeared at training). From each song, a single phrase was extracted and translated from Intermediate level to Essentials, using 4 variants of the model that differ in representation and augmentation. The matching phrases were also extracted from the ground truth Essentials arrangement for comparison.

The first 3 model variants used difference score only in the music representation they use: MIDI-like, Notes, and Notes+Hands. The fourth model variant uses the Notes+Hands representation and adds data augmentation with randomly varying parameters to about half of the training examples.

This resulted in 55 examples, which were then rated by 6 expert musicians who are familiar with the Essentials level guidelines. The examples were randomly ordered, and all identifiers of model version and ground truth were removed. Musicians were told all 5 examples are different model versions and were not aware of the details of the versions or of the presence of human-generated ground truth. Ratings between 1-5 were collected in 5 criteria:
1. Meeting Essentials level guidelines (Level)
2. Preserving musical content (Music)
3. Correctly assigning hands according to allowed hand positions (Hands)
4. Avoiding syntactic style errors such as crossover voices (Syntax).
5. Maintaining structure: avoiding missing or extra bars (Alignment)

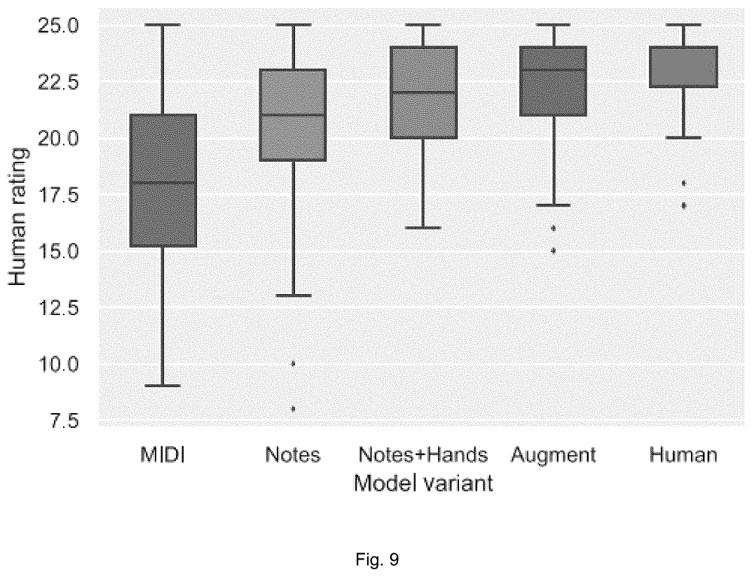

The maximum possible total score is 25. FIG. 9 shows the distributions of total scores for each model variant and for ground truth. These results show that the changes between model variants improved overall output quality. The best model (Augment) achieves ratings almost as high as the ground truth (Human).

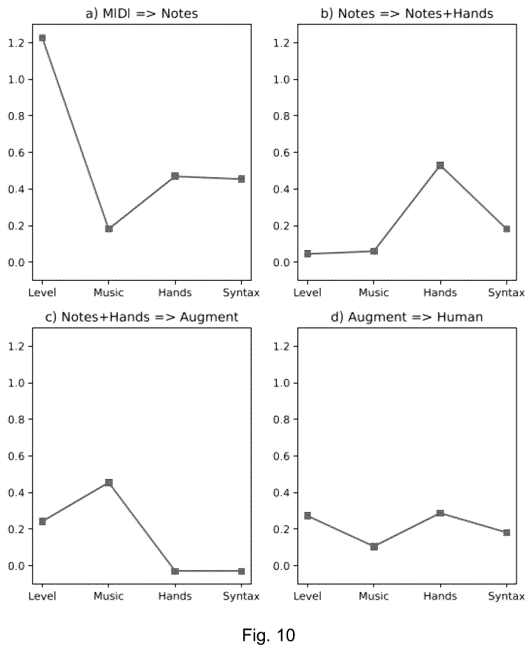

FIG. 10 schematically shows differences in average score, per criterion, between model variants: a) Moving from MIDI to Notes improved across all criteria, mostly Level. b) Adding hand information improved hand assignment. c) Augmentation improved preserving musical content. d) No particular criterion stands out in the difference from our best model to the human-generated ground truth.

The gains are shown in each criterion from the changes in each model variant. Some differences are easily explainable, for example, adding hand information improved the correct assignment of hands. Interestingly, the difference between the best model to the ground truth cannot be attributed to any specific criterion. The Alignment criterion from the figure was left out, as ratings under 5 were comparatively rare. The few ratings below 5 were given almost only to the MIDI model variant, which is more prone to alignment errors due to the lack of bar tokens.

Automated Evaluation

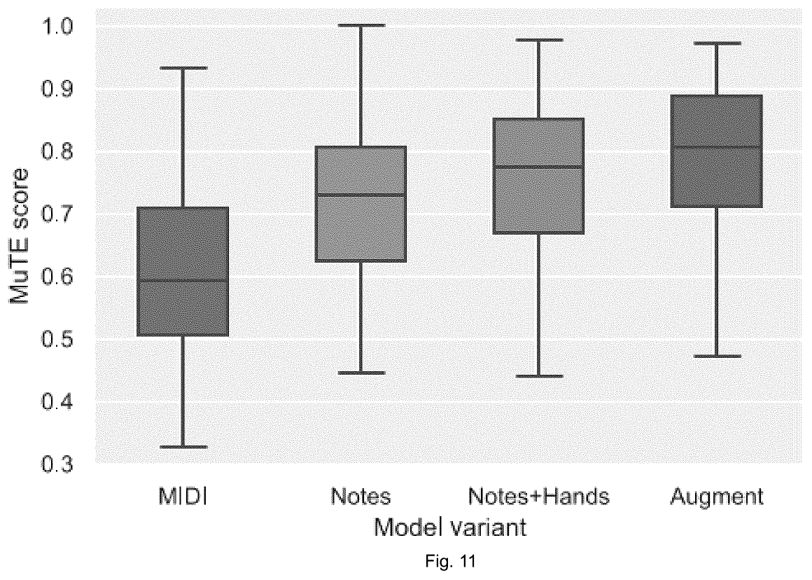

MuTE scores were calculated for the entire test set (58 phrases from 12 songs). The results are shown in FIG. 11 for “MIDI”, “Notes”, “Notes+Hands”, and “Augment”, and confirmed the human evaluation results. Additionally, for the 55 examples rated by human musicians, we compare the MuTE scores to the human ratings (the MuTE score of the ground truth compared to itself is always 1).

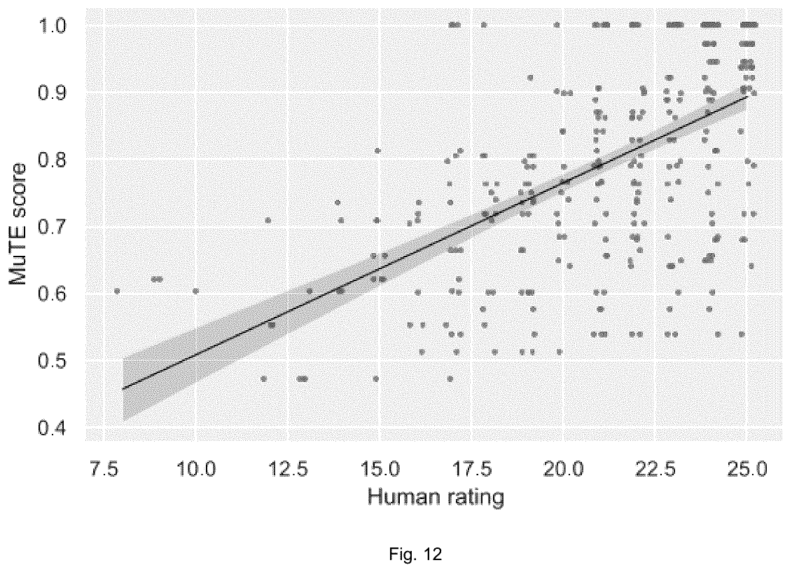

As shown in FIG. 12 it was found that MuTE scores are correlated with human ratings with a Pearson correlation coefficient of 0.56 (p=4 10⁻²⁹). While the correlation is not perfect, it showed that the MuTE score can be used as an estimator for human ratings. The similarity of FIGS. 6 and 4 further shows that MuTE scores can be used to rank models with similar results to human rankings, while being cheaper and faster to compute.

### CONCLUSION

The following task of playing level conversion was presented: converting piano arrangements from one difficulty level to another. Several experiments were run on this task and showed the importance of data representation and augmentation. The best model creates arrangements that achieve human ratings almost as high as reference arrangements composed by expert musicians. The MuTE evaluation metric was designed and showed that it correlates with human ratings.

### REFERENCES

[1] A. Vaswani, N. Shazeer, N. Parmar, J. Uszkoreit, Lee. Jones, A. N. Gomez, t. Kaiser, and I. Polosukhin, “Attention is all you need,” Advances in Neural Information Processing Systems, vol. 30, 2017.
[2] C.-Z. A. Huang, A. Vaswani, J. Uszkoreit, I. Simon, C. Hawthorne, N. Shazeer, A. M. Dai, M. D. Hoffman, M. Dinculescu, and D. Eck, “Music Transformer: Generating music with long-term structure,” in International Conference on Learning Representations, 2018.
[3] G. Mittal, J. Engel, C. Hawthorne, and I. Simon, “Symbolic music generation with diffusion models,” in Proceedings of the 22nd International Society for Music Information Retrieval Conference, 2021.
[4] J. Liu, Y. Dong, Z. Cheng, X. Zhang, X. Li, F. Yu, and M. Sun, “Symphony generation with permutation invariant language model,” arXiv preprint arXiv:2205.05448, 2022.
[5] C. Donahue, H. H. Mao, Y. E. Li, G. W. Cottrell, and J. McAuley, “LakhNES: Improving multi-instrumental music generation with cross-domain pre-training,” in International Society for Music Information Retrieval Conference (ISMIR), 2019.
[6] Y.-S. Huang and Y.-H. Yang, “Pop Music Transformer: Beat-based modeling and generation of expressive pop piano compositions,” in Proceedings of the 28th ACM International Conference on Multimedia, 2020.
[7] W.-Y. Hsiao, J.-Y. Liu, Y.-C. Yeh, and Y.-H. Yang, “Compound Word Transformer: Learning to compose full-song music over dynamic directed hypergraphs,” in Proceedings of the AAAI Conference on Artificial Intelligence, 2021.
[8] A. Muhamed, L. Li, X. Shi, S. Yaddanapudi, W. Chi, D. Jackson, R. Suresh, Z. Lipton, and A. J. Smola, “Transformer-GAN: symbolic music generation using a learned loss,” in 4th Workshop on Machine Learning for Creativity and Design at NeurIPS, 2020.
[9] K. Choi, C. Hawthorne, I. Simon, M. Dinculescu, and J. Engel, “Encoding musical style with Transformer autoencoders,” in International Conference on Machine Learning. PMLR, 2020, pp. 1899-1908.
[10] C. Payne, “MuseNet,” OpenAl Blog, 2019. [Online]. Available: https://openai.com/blog/musenet
[11] S. Sulun, M. E. P. Davies, and P. Viana, “Symbolic music generation conditioned on continuous-valued emotions,” IEEE Access, vol. 10, 2022.
[12] K. Chen, W. Zhang, S. Dubnov, G. Xia, and W. Li, “The effect of explicit structure encoding of deep neural networks for symbolic music generation,” in 2019 International Workshop on Multilayer Music Representation and Processing (MMRP). IEEE, 2019.
[13] Y.-J. Shih, S.-L. Wu, F. Zalkow, M. Muller, and Y.-H. Yang, “Theme Transformer: Symbolic music generation with theme-conditioned transformer,” IEEE Transactions on Multimedia, 2022.
[14] J. Ens and P. Pasquier, “MMM: Exploring conditional multi-track music generation with the Transformer,” arXiv preprint arXiv:2008.06048, 2020.
[15] Y. Ren, J. He, X. Tan, T. Qin, Z. Zhao, and T.-Y. Liu, “PopMAG: Pop music accompaniment generation,” in Proceedings of the 28th ACM International Conference on Multimedia, 2020.
[16] M. Suzuki, “Score Transformer: Transcribing quantized MIDI into comprehensive musical score,” in Late-Breaking Demo Session of the 22nd International Society for Music Information Retrieval Conference, 2021.
[17] “Piano fingering estimation and completion with Transformers,” in Late-Breaking Demo Session of the 22nd International Society for Music Information Retrieval Conference, 2021.
[18] C. Geerlings and A. Meroño-Peñuela, “Interacting with GPT-2 to generate controlled and believable musical sequences in ABC notation,” in Proceedings of the 1st Workshop on NLP for Music and Audio (NLP4MusA), 2020, pp. 49-53.
[19] B. Sturm, J. F. Santos, O. Ben-Tal, and I. Korshunova, “Music transcription modelling and composition using deep learning,” in 1st Conference on Computer Simulation of Musical Creativity, 2016.
[20] S. Dai, Z. Zhang, and G. G. Xia, “Music style transfer: A position paper,” in Proceeding of the International Workshop on Musical Metacreation (MUME), 2018.
[21] G. Brunner, A. Konrad, Y. Wang, and R. Wattenhofer, “MIDI-VAE: Modeling dynamics and instrumentation of music with applications to style transfer,” in 19th International Society for Music Information Retrieval Conference (ISMIR), 2018.
[22] G. Brunner, Y. Wang, R. Wattenhofer, and S. Zhao, “Symbolic music genre transfer with CycleGAN,” in IEEE 30th International Conference on Tools with Artificial Intelligence (ICTAI), 2018, pp. 786-793.
[23] G. Brunner, M. Moayeri, O. Richter, R. Wattenhofer, and C. Zhang, “Neural symbolic music genre transfer insights,” in Joint European Conference on Machine Learning and Knowledge Discovery in Databases, 2019, pp. 437-445.
[24] O. Cifka, U. Ş imşekli, and G. Richard, “Supervised symbolic music style translation using synthetic data,” in 20th International Society for Music Information Retrieval Conference (ISMIR), 2019.
[25] D. Temperley, “What's key for key? The Krumhansl-Schmuckler key-finding algorithm reconsidered,” Music Percep-tion, vol. 17, no. 1, pp. 65-100, 1999.
[26] N. Fradet, J.-P. Briot, F. Chhel, A. E. F. Seghrouchni, and N. Gutowski, “MidiTok: A Python package for MIDI file tokenization,” in Late-Breaking Demo Session of the 22nd International Society for Music Information Retrieval Conference, 2021.
[27] S. Oore, I. Simon, S. Dieleman, D. Eck, and K. Simonyan, “This time with feeling: Learning expressive musical performance,” Neural Computing and Applications, 2018.
[28] D. S. Park, W. Chan, Y. Zhang, C.-C. Chiu, B. Zoph, E. D. Cubuk, and Q. V. Le, “SpecAugment: A simple data augmentation method for automatic speech recognition,” in Interspeech, 2019.
[29] H.-W. Dong, K. Chen, J. McAuley, and T. Berg-Kirkpatrick, “MusPy: A toolkit for symbolic music generation,” in Proceedings of the 21st International Society for Music Information Retrieval Conference (ISMIR), 2020.
[30] M. Lewis, Y. Liu, N. Goyal, M. Ghazvininejad, A. Mohamed, O. Levy, V. Stoyanov, and L. Zettlemoyer, “BART: Denoising sequence-to-sequence pre-training for natural language generation, translation, and comprehension,” in Proceedings of the 58th Annual Meeting of the Association for Computational Linguistics, 2020, pp. 7871-7880.
[31] T. Wolf, L. Debut, V. Sanh, J. Chaumond, C. Delangue, A. Moi, P. Cistac, T. Rault, R. Louf, M. Funtowicz, J. Davison, S. Shleifer, P. von Platen, C. Ma, Y. Jernite, J. Plu, C. Xu, T. L. Scao, S. Gugger, M. Drame, Q. Lhoest, and A. M. Rush, “Transformers: State-of-the-art natural language processing,” in Proceedings of the 2020 Conference on Empirical Methods in Natural Language Processing: System Demonstrations. Association for Computational Linguistics, 2020, pp. 38-45.
[32] D. P. Kingma and J. Ba, “Adam: A method for stochastic optimization,” in 3rd International Conference on Learning Representations, ICLR, 2015.
[33] D. Ippolito, R. Kriz, J. Sedoc, M. Kustikova, and C. Callison-Burch, “Comparison of diverse decoding methods from conditional language models,” in Proceedings of the 57th Conference of the Association for Computational Linguistics, A C L, 2019, pp. 3752-3762.
[34] L.-C. Yang and A. Lerch, “On the evaluation of generative models in music,” Neural Computing and Applications, vol. 32, no. 9, pp. 4773-4784, 2020.
[35] S. Wu and Y. Yang, “The Jazz Transformer on the front line: Exploring the shortcomings of Al-composed music through quantitative measures,” in Proceedings of the 21th International Society for Music Information Retrieval Conference (ISMIR), 2020, pp. 142-149.
[36] K. Papineni, S. Roukos, T. Ward, and W.-J. Zhu, “BLEU: a method for automatic evaluation of machine translation,” in Proceedings of the 40th annual meeting of the Association for Computational Linguistics, 2002, pp. 311-318.
[37] C. J. Van Rijsbergen, “Foundation of evaluation,” Journal of documentation, vol. 30, no. 4, pp. 365-373, 1974.
[38] S. Dixon and G. Widmer, “MATCH: A music alignment tool chest,” in International Society for Music Information Retrieval Conference (ISMIR), 2005, pp. 492-497.

The various features and steps discussed above, as well as other known equivalents for each such feature or step, can be mixed and matched by one of ordinary skill in this art to perform methods in accordance with principles described herein. Although the disclosure has been provided in the context of certain embodiments and examples, it will be understood by those skilled in the art that the disclosure extends beyond the specifically described embodiments to other alternative embodiments and/or uses and obvious modifications and equivalents thereof. Accordingly, the disclosure is not intended to be limited by the specific disclosures of embodiments herein.

Any digital computer system, module and/or engine exemplified herein can be configured or otherwise programmed to implement a method disclosed herein, and to the extent that the system, module and/or engine is configured to implement such a method, it is within the scope and spirit of the disclosure. Once the system, module and/or engine are programmed to perform particular functions pursuant to computer readable and executable instructions from program software that implements a method disclosed herein, it in effect becomes a special purpose computer particular to embodiments of the method disclosed herein. The methods and/or processes disclosed herein may be implemented as a computer program product that may be tangibly embodied in an information carrier including, for example, in a non-transitory tangible computer-readable and/or non-transitory tangible machine-readable storage device. The computer program product may directly loadable into an internal memory of a digital computer, comprising software code portions for performing the methods and/or processes as disclosed herein. The term “non-transitory” is used to exclude transitory, propagating signals, but to otherwise include any volatile or non-volatile computer memory technology suitable to the application.

Additionally or alternatively, the methods and/or processes disclosed herein may be implemented as a computer program that may be intangibly embodied by a computer readable signal medium. A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a non-transitory computer or machine-readable storage device and that can communicate, propagate, or transport a program for use by or in connection with apparatuses, systems, platforms, methods, operations and/or processes discussed herein.

The terms “non-transitory computer-readable storage device” and “non-transitory machine-readable storage device” encompasses distribution media, intermediate storage media, execution memory of a computer, and any other medium or device capable of storing for later reading by a computer program implementing embodiments of a method disclosed herein. A computer program product can be deployed to be executed on one computer or on multiple computers at one site or distributed across multiple sites and interconnected by one or more communication networks.

These computer readable and executable instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable and executable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable and executable instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

In the discussion, unless otherwise stated, adjectives such as “substantially” and “about” that modify a condition or relationship characteristic of a feature or features of an embodiment of the invention, are to be understood to mean that the condition or characteristic is defined to within tolerances that are acceptable for operation of the embodiment for an application for which it is intended.

Unless otherwise specified, the terms ‘about’ and/or ‘close’ with respect to a magnitude or a numerical value may imply to be within an inclusive range of −10% to +10% of the respective magnitude or value.

It should be noted that where an embodiment refers to a condition of “above a threshold”, this should not be construed as excluding an embodiment referring to a condition of “equal or above a threshold”. Analogously, where an embodiment refers to a condition “below a threshold”, this should not be construed as excluding an embodiment referring to a condition “equal or below a threshold”. It is clear that should a condition be interpreted as being fulfilled if the value of a given parameter is above a threshold, then the same condition is considered as not being fulfilled if the value of the given parameter is equal or below the given threshold. Conversely, should a condition be interpreted as being fulfilled if the value of a given parameter is equal or above a threshold, then the same condition is considered as not being fulfilled if the value of the given parameter is below (and only below) the given threshold.

It should be understood that where the claims or specification refer to “a” or “an” element and/or feature, such reference is not to be construed as there being only one of that element. Hence, reference to “an element” or “at least one element” for instance may also encompass “one or more elements”.

As used herein the term “configuring” and/or ‘adapting’ for an objective, or a variation thereof, implies using materials and/or components in a manner designed for and/or implemented and/or operable or operative to achieve the objective.

Unless otherwise stated or applicable, the use of the expression “and/or” between the last two members of a list of options for selection indicates that a selection of one or more of the listed options is appropriate and may be made, and may be used interchangeably with the expressions “at least one of the following”, “any one of the following” or “one or more of the following”, followed by a listing of the various options.

As used herein, the phrase “A,B,C, or any combination of the aforesaid” should be interpreted as meaning all of the following: (i) A or B or C or any combination of A, B, and C, (ii) at least one of A, B, and C; and (iii) A, and/or B and/or C. This concept is illustrated for three elements (i.e., A,B,C), but extends to fewer and greater numbers of elements (e.g., A, B, C, D, etc.).

It is noted that the terms “operable to” or “operative to” can encompass the meaning of the term “adapted or configured to”. In other words, a machine “operable to” or “operative to” perform a task can in some embodiments, embrace a mere capability (e.g., “adapted”) to perform the function and, in some other embodiments, a machine that is actually made (e.g., “configured”) to perform the function.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 4, from 1 to 4, from 1 to 5, from 2 to 4, from 2 to 6, from 4 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It should be appreciated that combinations of features disclosed in different embodiments are also included within the scope of the present inventions.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A method for providing a user with musical notations for playing a musical instrument, the method comprising:
receiving source musical notation data descriptive of source musical notation information that can be played with a musical instrument and/or sung by one or more users;
analyzing the received source musical notation data for generating a source notation analysis output;
receiving at least one target requirement defining target musical notation information; and
providing, based on the source notation analysis output and the at least one target requirement, target musical notation data descriptive of target musical notation information.

2. The method of claim 1, wherein the providing of target musical notation data includes adapting the source musical notation data to arrive at the target musical notation data.

3. The method of claim 1, wherein the providing of target musical notation data includes selecting, based on the source notation analysis output and the at least one target requirement, a set of target musical notation data from a plurality of sets of available target musical notation data.

4. The method of claim 1, wherein the source notation analysis output relates to one of the following:
identifying one or more instruments that can be engaged for playing the source musical notation information;
a source difficulty level of the source musical notation;
a source style relating to the source musical notation information;
or any combination of the aforesaid.

5. The method of claim 1, wherein the at least one target requirement of the target musical notation information relates to one of the following:
at least one target difficulty level;
at least one target style;
at least one target musical instrument for playing the target musical notation information;
at least one physiological characteristic of at least one target user playing an instrument according to the target musical information;
at least one social characteristic of the at least one target user; or any combination of the aforesaid.

6. The method of claim 5, wherein the at least one target requirement is used to define one or more of the following musical notation characteristics:
scale; beats per minute; time signature; clefs; tempo; note structure such as note length, rest lengths;
rhythmic style; and playing setting.

7. The method of claim 5, wherein the target difficulty level is characterizable by one of the following musical notation characteristics:
scale; beats per minute; time signature; clefs; tempo; note structure such as note length, rest lengths;
rhythmic style; playing setting, or any combination of the aforesaid.

8. The method of claim 1, wherein the adapting of the source musical notation data is performed by employing a Machine Learning (ML) Model.

9. The method of claim 1, comprising displaying information relating to the target musical information data.

10. The method of claim 1, wherein the target musical notation information is a simplified or more complex version of the source musical notation information.

11. A system for providing a user with musical notations for playing a musical instrument, the system comprising:
at least one processor configured to execute computer code instructions stored in the at least one memory for performing:
receiving source musical notation data descriptive of source musical notation information that can be played with a musical instrument and/or sung by one or more users;
analyzing the received source musical notation data for generating a source notation analysis output;
receiving at least one target requirement defining target musical notation information;
automatically providing, based on the source notation analysis output and the at least one target requirement, target musical notation data descriptive of target musical notation information.

12. The system of claim 11, wherein the providing of target musical notation data includes adapting the source musical notation data to arrive at the target musical notation data.

13. The system of claim 11, wherein the providing of target musical notation data includes selecting, based on the source notation analysis output and the at least one target requirement, a set of target musical notation data from a plurality of sets of available target musical notation data.

14. The system of claim 11, wherein the source notation analysis output relates to one of the following:
identifying one or more instruments that can be engaged for playing the source musical notation information;
a source difficulty level of the source musical notation;
a source style relating to the source musical notation information; or any combination of the aforesaid.

15. The system of claim 11, wherein the at least one target requirement of the target musical notation information relates to one of the following:
at least one target difficulty level;
at least one target style;
at least one target musical instrument for playing the target musical notation information;
at least one physiological characteristic of at least one target user playing an instrument according to the target musical information;
at least one social characteristic of the at least one target user; or any combination of the aforesaid.

16. The system of claim 15, wherein the at least one target requirement is used to define one of the following musical notation characteristics:
scale; beats per minute; time signature; clefs; tempo; note structure such as note length, rest lengths;
rhythmic style; and playing setting, or any combination of the aforesaid.

17. The system of claim 15, wherein the target difficulty level is characterizable by one of the following musical notation characteristics:
scale; beats per minute; time signature; clefs; tempo; note structure such as note length, rest lengths;
rhythmic style; playing setting, or any combination of the aforesaid.

18. The system of claim 11, wherein the adapting of the source musical notation data is performed by employing a Machine Learning (ML) Model.

19. The system of claim 11, configured to display information relating to the target musical information data.

20. The system of claim 11, wherein the target musical notation information is a simplified or more complex version of the source musical notation information.
